(19) United States
(12) Patent Application Publication
(10) Pub. No.: US 2026/0175061 A1
(43) Pub. Date: Jun. 25, 2026

(54) FIRE SUPPRESSION SYSTEM

(71) Applicant: Fireaway Inc., Minnetonka, MN (US)

(72) Inventors: Jason Robert Fuglsby, Shoreview, MN (US); Michael Lawrence Brown, New Brighton, MN (US)

(21) Appl. No.: 19/409,153

(22) Filed: Dec. 4, 2025

Related U.S. Application Data
(60) Provisional application No. 63/729,116, filed on Dec. 6, 2024.

(51) Int. Cl. A62C 35/13; A62C 35/02

(52) U.S. Cl. CPC A62C 35/13; A62C 35/023

(57) ABSTRACT

Fire suppression systems and methods, such as for actuating a number of aerosol generators initiated by a single control device of a fire suppression device, can be used to actuate at least two aerosol generators. A method can include detecting a fire event at a location using at least one of a thermal signal, an electrical signal, or a manual signal, communicating the fire event to a first fire suppression device, dispensing an aerosol fire suppression agent from the first fire suppression device, communicating the fire event to a second fire suppression device through the first fire suppression device, and dispensing an additional aerosol fire suppression agent from the second fire suppression device at the location.

### CLAIM OF PRIORITY

This application claims the benefit of priority under 35 U.S.C. § 119 (e) to U.S. Provisional Patent Application Ser. No. 63/729,116, filed on Dec. 6, 2024, which is incorporated by reference herein in its entirety.

### BACKGROUND

Water sprinklers have traditionally been installed in buildings to control and extinguish fires. Other fire extinguishing systems, such as gaseous firefighting agents, have been developed for applications such as in engine rooms on ships, computer rooms, and electrical equipment rooms. Some popular gaseous systems used halon gases until production of such systems was terminated due to their adverse effects on the environment.

Each fire extinguishing agent has different performance characteristics and different application requirements. Some agents and systems include gaseous chemical agents similar to halons except that today's gaseous agents are engineered to have minimal detrimental effects on the environment. Other systems can use fine water spray or water mist, and still others can use aerosol agents, such as comprising fine particulate extinguisher matter. These various approaches have different mechanisms of extinguishing and suppressing fire, exhibit differences in performance depending on the circumstances of the fire and system, and further require or use different equipment to dispense the various agents.

Some agents proposed to replace halons are gaseous agents that resemble halons, including various chemical agents stored in pressurized tanks and discharged through valves and a pipe distribution system. The term “in-kind” is used in some cases to describe such gaseous agents because they resemble a halon agent and can have essentially the same or similar methods of application and storage. Although similar to halons, which interrupt the chemical reaction of a fire, gaseous replacements generally use cooling as their main extinguishing mechanism. One well-recognized halon replacement agent is heptafluoropropane, or HFC-227ea.

### SUMMARY

Systems and methods discussed herein are configured for suppressing a fire event at a location such as a building, facility, business, etc. For the purposes of this disclosure, fire suppression can include one or more of extinguishing, controlling, mitigating, or otherwise decreasing effects or presence of a fire in a location or structure. The systems and methods discussed herein can include or use multiple fire suppression devices that deploy fire suppression agents in a coordinated manner to suppress a fire.

In an example, a method for suppressing a fire using the systems described herein can include detecting a fire event and communicating the detection result to at least one of a plurality of fire suppression devices. The at least one fire suppression device can communicate to the other(s) of the plurality of fire suppression devices that the fire event has been detected. The at least one fire suppression device can communicate directly to each of the other fire suppression devices, or the at least one fire suppression device can communicate using a serial communication channel, or daisy chain, to reach the other(s) of the fire suppression devices. In an example, each of the fire suppression devices can be configured to initiate the communication with one or more of the other devices in the network. In this way, a central control is not needed to communicate to all of the plurality of fire suppression devices. Instead, a central control, if available, can communicate with a single one of the fire suppression devices, and that device can, in turn, communicate with the others.

The method can further include delaying actuating one or more of the fire suppression devices in response to receiving the detection signal that a fire event has occurred. The delay can allow personnel to exit the location or structure in order to avoid being present when, for example, aerosol generators are actuated. Further, a horn, siren, or other audible indication can be triggered to alert the personnel that an actuation of the fire suppression device(s) is forthcoming. The delay can occur across all of the plurality of fire suppression devices thereby preventing any one of the devices from actuating early. In an example, diminishing the fire event or extinguishing the fire is enhanced due at least in part to the coordinated actuation of the plurality of fire suppression devices. In an example, the plurality of fire suppression devices use respective aerosol generators to suppress the fire event substantially concurrently or in a staggered released, depending on how the system is configured.

This Summary is intended to provide a brief overview of subject matter of the present application. It is not intended to provide an exclusive or exhaustive explanation of the invention or inventions discussed herein. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a schematic of a fire suppression system including fire suppression devices.

FIG. 2 illustrates generally a schematic diagram of a plurality of fire suppression devices.

FIG. 3 illustrates generally an angled schematic view of a top portion of a fire suppression device.

FIG. 4 illustrates generally a front view of a fire suppression device.

FIG. 5 illustrates generally an example of a method that includes actuating a plurality of fire suppression devices.

### DETAILED DESCRIPTION

Systems and methods for fire suppression or fire extinguishing can include aerosol-based systems, among others. An aerosol extinguishing agent can have particular properties and characteristics. For example, an aerosol can include solid particulates with an average diameter that is in a range of about 1 to 10 micrometers, such as suspended in air or suspended in another gas. In an example, an aerosol agent includes ultra-fine dry particles that are under 5 μm in diameter on average, and can provide improved extinguishing performance per unit volume of agent discharged relative to, for example, a gas extinguisher. Such aerosol agents extinguish principally by interrupting the chemical chain reaction of a fire. Unlike water-based agents, fine particulate aerosol agents can have three-dimensional flooding characteristics, which can be more effective in overcoming obstacles than water alone.

An aerosol agent can be delivered using an aerosol generator. In an example, an aerosol generator operates by combusting a portion of a solid material inside a generator device. The generator device releases a cloud of the agent, such as can include the solid particulates and a gaseous carrier (e.g., nitrogen). This type of system is a pyrotechnic aerosol or a condensed aerosol system. Alternatively, an aerosol agent can include a particulate agent that is provided in a pressurized container, such as together with a carrier gas (e.g., nitrogen). Such an agent stored in a pressurized container, sometimes referred to as a dispersed aerosol, can be similar to a common fire extinguisher and, in an example, can be discharged through valves and pipes.

Aerosol-based systems can be less effective as a volume of a location or structure increases. The reduced effectiveness can be attributed, at least in part, to the inability to effectively spread the aerosol across the entire area of the location or structure. Dispensed aerosol agents can disperse throughout a location or structure, with differing amounts of agent available at various portions of the location. Fire extinguishing performance with aerosols can be improved by, for example, increasing an amount of agent released into the environment, increasing a rate of discharge, and/or by providing one or more aerosol generators at different locations in the environment.

The present disclosure recognizes the importance of providing efficient and effective fire control and extinguishment for a fire at a location. This can include ensuring or encouraging a more even distribution of aerosol extinguisher agents, for example, in large or spread out structures or buildings or in compartments that include one or more obstructions. For example, by activating multiple fire suppression devices at a location, the aerosol can be dispersed over a greater area of the location and accordingly additional fire abatement coverage can be obtained. Further, one fire suppression device activating subsequent fire suppression devices in a serial chain or parallel manner can be effective to increase a rate or effectiveness of extinguishment of a fire.

Some fire extinguishing approaches can individually activate each of multiple fire suppression devices either from a central location or as each fire suppression device detects the fire individually. In contrast with such an individual extinguisher approach, the present systems and methods include a fire suppression system that includes two or more fire suppression devices that are activated when at least one of the fire suppression devices detects the fire and/or is activated in a serial manner.

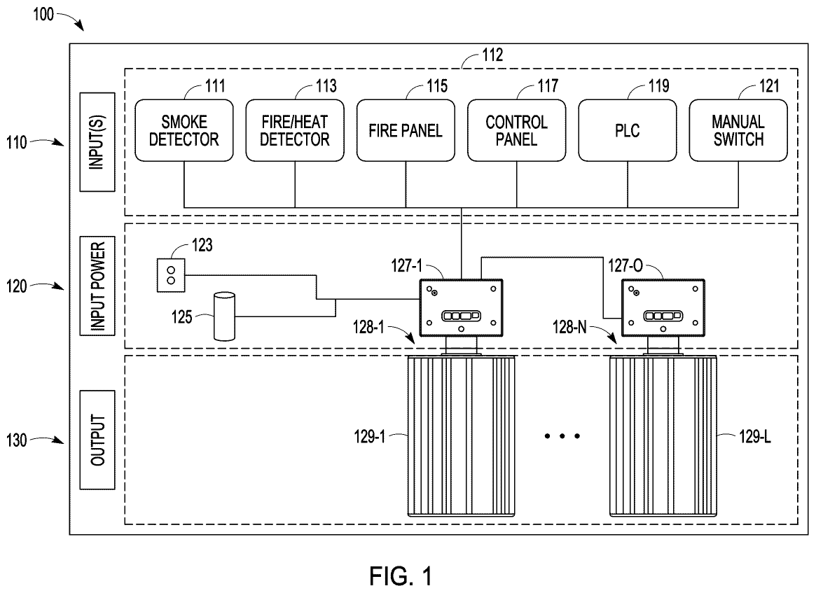

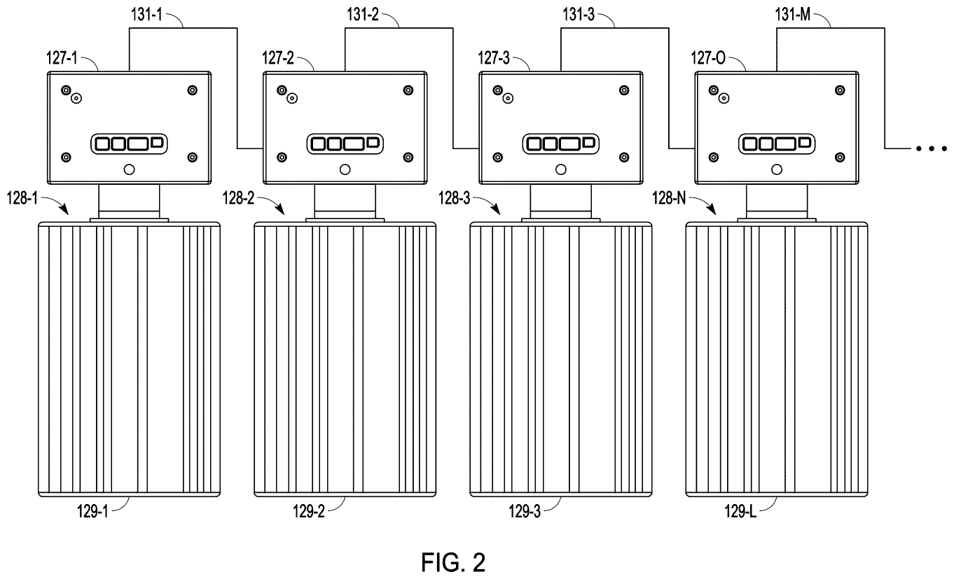

The example systems discussed herein provide a marked improvement in fire extinguishment using the activation of more than one fire suppression device in succession, such as in response to at least one fire suppression device detecting the fire. For example, FIGS. 1-2 illustrate a serial or daisy chain setup for a plurality of the fire suppression devices to demonstrate the importance of activation of more than one fire suppression device. That is, the improvement in fire extinguishment exhibited by the present systems and methods indicate that the improvement is not one of merely a degree of difference but rather one of a different kind of performance. The fire suppression system can be used in an Energy Storage System or in other commercial and industrial applications using aerosol fire suppression mechanisms, among others.

FIG. 1 illustrates generally a schematic of a fire suppression system 100. The fire suppression system 100 includes a plurality of input(s) 110 (e.g., through input devices), input power 120, and outputs 130 associated with or in communication with a plurality of fire suppression devices 128-1, 128-N (hereinafter referred to collectively as fire suppression devices 128). While two fire suppression devices 128-1 and 128-N are illustrated in FIG. 1, examples are not so limited. For example, the fire suppression device 128-N indicates that there can be at least N number of fire suppression devices.

The fire suppression device 128-1 includes a control device 127-1 and an aerosol generator 129-1 and the fire suppression device 128-N includes a control device 127-O and an aerosol generator 129-L (hereinafter aerosol generators 129-1, 129-L are referred to collectively as aerosol generators 129, and control devices 127-1, 127-O are referred to collectively as control devices 127). The control devices 127 can include hardware, software, and/or firmware to perform a number of fire suppression operations and/or to monitor the inputs 110. The control devices 127 can include a printed circuit board (PCB) and the capabilities of the control devices 127 described herein can be implemented using a processor or other purpose-built circuitry incorporated in the fire suppression devices 128. A housing of the control devices 127 can protect the control circuitry therein.

The aerosol generators 129-1, 129-L for fire suppression are specialized devices that produce a fine mist or cloud of aerosol particles designed to extinguish fires. The aerosol generators 129-1, 129-L release a chemical aerosol that works by interrupting the chemical reaction of the fire, thereby suppressing it. This technology is often used in environments where traditional fire suppression methods (like water or foam) might not be practical or could cause damage to equipment or sensitive materials. When activated, the aerosol generators 129-1, 129-L each release a solid or liquid compound that undergoes a chemical reaction to produce fine, solid particles and gases. These particles are dispersed into the environment, where they interfere with the combustion process. The aerosol particles work by absorbing heat and disrupting the free radicals that are essential for sustaining the chemical reaction of the fire. Without these radicals, the fire cannot continue to burn, leading to its suppression.

The inputs 110 can be used to detect potential fire events or hazards. In an example, each of the inputs 110 can connect directly to each of the plurality of fire suppression devices 128 using a variety of differing electric connectors and/or adapters. The inputs 110 to the plurality of fire suppression devices 128 can include, among other things, input devices including a smoke detector 111, a fire or heat detector 113, a fire panel 115, a control panel 117, a programmable logic controller (PLC) 119, and/or a manual switch 121. The smoke detector 111 can include an electronic fire-protection device that automatically senses the presence of smoke, as a key indication of a fire event. The fire or heat detector 113 can be a type of alarm-initiating device that can be an electronic or electro-mechanical device designed to detect the presence of heat either at a fixed temperature or a rate-of-rise in temperature (e.g., a threshold rise in temperature over a threshold period of time), or a combination of both. While the inputs 110 are illustrated as external to the fire suppression devices 128, examples are not so limited. The inputs 110 may be included in each of the control devices 127 and/or on another portion of the fire suppression device 128 such that the detection of the fire event is internal to the fire suppression device 128 itself rather than communicated from an external source.

In an example, the fire panel 115 can be a fire alarm control panel that is a central hub of operations for a fire alarm system. The fire panel 115 can include hardware, software, and/or firmware to perform the described operations. For example, the fire panel 115 can communicate instructions or control signals to each component to which the fire panel 115 is connected. An example of the control panel 117 can include building controls that collect real-time data from various building systems to regulate, monitor, improve, and control building system operations. The PLC 119 can be a computing device used for industrial automation. The PLC 119 can reliably detect alarms and initiate an orderly system control or shutdown during emergencies. The manual switch 121 can include, for example, a pull-pin in one or each of the fire suppression devices 128. In an example, the pull-pin can be located between two photodetectors. Once the pull-pin has been removed, the signal can be complete and the fire aerosol generator can initiate dispensing of a fire suppression aerosol. While specific inputs are listed, examples are not so limited and may include additional detection devices to detect a fire event.

In some examples, the control devices 127 can monitor each of the inputs 110 to determine whether conditions are met to actuate the respective aerosol generators 129. For example, a specified combination of signals may be used to avoid false positives or to determine a particular type of fire event. Any combination of signals from any combination of the inputs 110 may be used and/or combined to indicate a fire event.

Each of the fire suppression devices 128 can include or can be connected to a power source. For example, the fire suppression devices 128 can be connected to a power source 123 (e.g., main power) and/or a battery source 125 as a backup in case the power source 123 is lost. A PCB of each of the control devices 127 can handle a wide range of voltage/current inputs, from wall power to power supplies. The PCB can use the correct adapter to convert the external power to the PCB's power requirements.

The output 130 of the fire suppression system 100 can include or use the aerosol generators 129. The aerosol generators 129 can be respectively actuated in response to control signals from the control devices 127. In an example, the control devices 127 can delay the actuation to provide time for personnel or other activities to occur prior to release of aerosol from the aerosol generators 129. In this way, the input(s) 110 can cause (by indicating a fire event) the control devices 127 to operate and cause an output 130 (such as actuation of the aerosol generators 129) to occur.

FIG. 2 illustrates generally a schematic diagram of a plurality of fire suppression devices 128-1, 128-2, 128-3, . . . , 128-N that are coupled together to form a network of fire suppression devices. The plurality of fire suppression devices 128 can include a plurality of corresponding respective control devices 127-1, 127-2, 127-3, . . . , 127-N and a plurality of corresponding respective aerosol generators 129-1, 129-2, 129-3, . . . , 129-L. The first fire suppression device 128-1 can be connected to the second fire suppression device 128-2 through a connector 131-1 or communication channel. The second fire suppression device 128-2 can be connected to the third fire suppression device 128-3 through a connector 131-2. The third fire suppression device 128-3 can be connected to the fourth fire suppression device 128-4 through a connector 131-3. The fourth fire suppression device 128-N can be connected to an additional fire suppression device (not pictured but indicated by the ellipsis) through a connector 131-M, and so on.

In the example of FIG. 2, each of the aerosol generators 129 can be of a same or different type of aerosol generator, such as can be provided at different locations inside a facility. In some examples, the aerosol generators 129 can include, for example, Stat-X® 2500-E generators, such as can include an aerosol-forming chemical pellet with a nominal mass of 2500 grams and nominal discharge time of about 36 seconds. In some examples, the aerosol generators 129 can include, for example, Stat-X® 1500-E generators, such as can include an aerosol-forming chemical pellet with a nominal mass of 1500 grams and nominal discharge time of about 23 seconds.

Various aerosol-based extinguishers can be used according to the described systems and methods. For example, pyrotechnically-generated aerosols can be used, or non-pyrotechnically-generated aerosols can be used. In an example, the various aerosol extinguishers, aerosol generators, or systems configured to use an aerosol extinguisher, can be described in one or more of the following patent or publication documents: U.S. Pat. No. 7,614,458, “Ignition Unit for Aerosol Fire-retarding Delivery Device”; U.S. Pat. No. 7,461,701, “Aerosol Fire-retarding Delivery Device”; U.S. Pat. No. 7,389,825, “Aerosol Fire-retarding Delivery Device”; U.S. Patent Application Publication No. 2007-0039744, “Tunnel Fire Protection System”; U.S. Patent Application Publication No. 2007-0079972, “Manually Activated, Portable Fire-extinguishing Aerosol Generator”; U.S. Patent Application Publication No. 2007-0068683, “Manually Activated, Portable Fire-extinguishing Aerosol Generator”; U.S. Patent Application Publication No. 2007-0068687, “Manually Activated, Portable Fire-extinguishing Aerosol Generator Having a Plurality of Discharge Ports Circumferentially Disposed About the Surface of the Casing”; U.S. Pat. No. 7,832,493, “Portable Fire Extinguishing Apparatus and Method”; U.S. Pat. No. 9,227,096, “Fire Suppression Apparatus and Method for Using the Same in an Enclosed Compartment”; U.S. Pat. No. 9,092,966, “Dual Release Circuit for Fire Protection System”; U.S. Patent Application Publication No. 2016-0346577, “Aerosol Fire Extinguishing Device for Installation on Moving Object, and Aerosol Fire Extinguishing Agent for use in Same”. Other aerosol extinguishers, aerosol generators, or systems configured to use an aerosol extinguisher, can similarly be used.

In operation and during a fire event, a second fire suppression device 128-2 can receive an event-indicating first signal from an input (e.g., one of inputs 110 in FIG. 1) indicating that a fire event or a parameter associated with a fire event has been detected. In response to receiving the first signal, the control device 127-2 of the second fire suppression device 128-2 can activate the second aerosol generator 129-2. Further, in response to receiving the event-indicating first signal, the second fire suppression device 128-2 can send an event-indicating second signal to the third fire suppression device 128-3. In response to receiving the second signal, the third fire suppression device 128-3 can activate the second aerosol generator 129-3.

Communication between or among the fire suppression devices 128 can, in some examples, be directional or conditional. In some examples, the second fire suppression device 128-2 can be configured to send an event-indicating signal to the first suppression device 128-1 substantially concurrently with sending the event-indicating second signal to the third fire suppression device 128-3. In another example, the second fire suppression device 128-2 only sends the second signal to the third suppression device 128-3. In the situation where the second fire suppression device 128-2 only sends the second signal to the third fire suppression device 128-3, the third fire suppression device 128-3 can send an event-indicating third signal to the fourth fire suppression device 128-4 and the fourth fire suppression device 128-4 can send an event-indicating fourth signal to the first fire suppression device 128-1. In this way, in this example, a circular daisy chain can be implemented. However, if the second fire suppression device 128-2 sends an event-indicating signal to both the first 128-1 and third 128-3 fire suppression devices, the third fire suppression device 128-3 may only send to the fourth fire suppression device 128-4, thereby ending the chain with all of the plurality of fire suppression devices 128 causing actuation of their respective aerosol generators 129. In this way, no matter which fire suppression device 128 receives the signal indicating the fire event, each of the fire suppression devices 128 will cause actuation of its respective aerosol generator 129. The activation of a plurality of fire suppression devices 129 can provide additional fire suppressant in large spaces or where significant leakage may occur.

In some examples, a delay for a specified period of time can occur between receiving a signal that indicates a fire event and the actuation of the aerosol generator 129. This delay can be used to allow personnel in a building to exit prior to release of an aerosol agent. The delay range can be as little as 5 seconds and up to 1 minute, in some examples. Additionally, the delay can allow some time to shut down equipment to avoid damaging the equipment. In some examples, the delay can allow some time to close ventilation systems to achieve or maintain a particular aerosol concentration or density in a given environment. In some examples, a horn or strobe annunciator may be engaged to notify personnel to leave prior to actuating the aerosol generators 129. In some examples, subsequent to receiving the first fire event-indicating signal and prior to dispensing the first aerosol fire suppression agent, a control of a first fire suppression device can determine whether to dispense the first aerosol fire suppression agent based on a number of criteria, such as temperature range, number of fire suppression devices activated or notified of a fire event, etc.

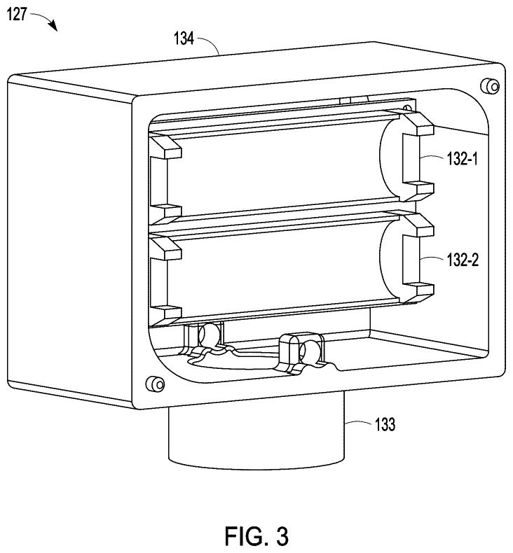

FIG. 3 illustrates generally a perspective view of a control device 127. The control device 127 can include battery holder portions 132-1, 132-2 to hold at least two batteries. The batteries can be used as a backup in case a power source fails or is no longer functional. The control device 127 is illustrated with a cover removed in order to illustrate the battery holder portions 132-1, 132-2. An outer housing 134 of the control device 127 can protect the batteries within the control device 127 and also protect any devices or components within the control device 127, such as a printed circuit board and/or other circuitry and components.

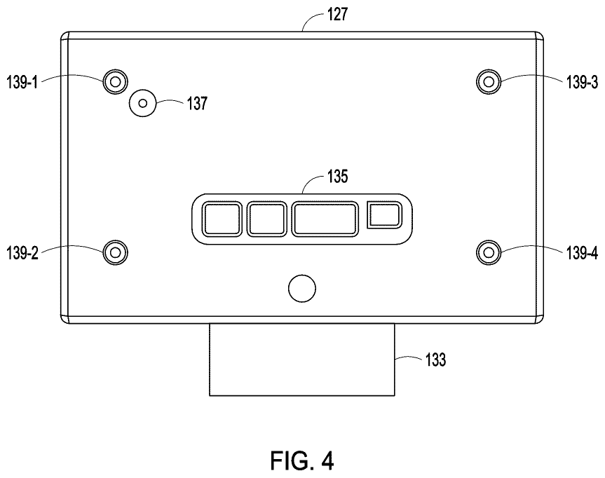

FIG. 4 illustrates generally a front view of a control device 127 of a fire suppression system. The control device 127 includes a number of fasteners 139-1, 139-2, 139-3, 139-4. The fasteners 139 can be used to secure a cover on the control device 127. In an example, the control device 127 can include an interconnect 135. The interconnect 135 can comprise one or more interfaces or connectors that are used to couple power and/or data to the control device 127. In an example, one or more of the inputs 110 is coupled to the control device 127 using the interconnect 135.

The control device 127 can include a light indicator 137 used to indicate a status of the fire suppression device. The status of the fire suppression device can include one of a remaining battery life, a main or reserve power availability, and whether the aerosol fire suppression agent has been dispensed from the first aerosol generator. Status data associated with the status can be stored in the control device 127 of the fire suppression device and can provide input for the light indicator 137 to designate the status.

In some examples, status data can be shared between or among other fire suppression devices (e.g., within a same group of networked devices). Accordingly, information from a particular fire suppression device can be shared or coordinated with information from one or more others. In an example, information related to each device's battery life and/or information about each device's status with regard to a fire event can be shared. For example, a low battery life may be indicated using the light indicator 137 (or other indicated) to communicate to personnel that a battery change is required. In the event a battery is low, a control device of one or all of the fire suppression devices in the network may provide the alert. In some examples, the light indicators 137 of each of the fire suppression devices may be synchronized such that a fire event is indicated on each of the fire suppression devices. In some examples, the light indicators 137 of each of the fire suppression devices may be different to indicate the different statuses of each of the fire suppression devices.

In an example, the control device 127 can comprise a housing with a cylindrical neck portion 133 that can slide over or through a portion of the aerosol generator (shown as aerosol generators 129 in FIGS. 1-2) in order to secure the aerosol generator to the control device 127. Other mechanical structures or means can similarly be used to couple the housing to the aerosol generator portion of the device.

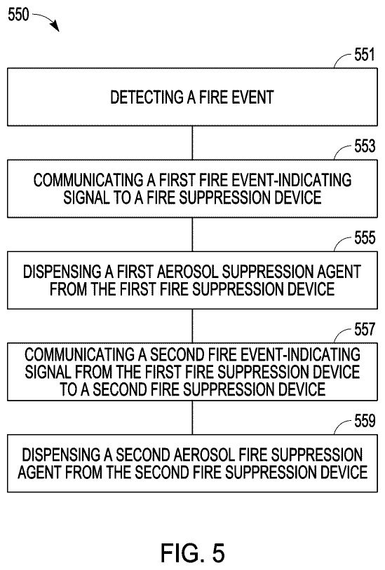

FIG. 5 illustrates generally an example of a method 550 that includes activating a plurality of fire suppression devices. At operation 553, the method 550 includes receiving a fire event-indicating signal at a first fire suppression device. The fire event can be communicated to the first fire suppression device through a communication channel that communicates the data from the number of inputs 110 or input devices to the first fire suppression device. For example, the inputs can include one of a smoke detector, fire/heat detector, manual switch, etc. (e.g., as illustrated in FIG. 1). The first fire suppression device can respond by actuating. In some examples, the control device of a fire suppression device (such as the first fire suppression device in this example) can receive the fire event-indicating signal and determine a response. The response can include actuating the aerosol generator or not actuating the aerosol generator. For example, each of the control devices can receive a temperature-indicating signal and independently determine whether to actuate. The control device may determine whether to actuate based on different locations of the associated fire suppression device and the different tolerances or sensitivities to that particular temperature and/or fire event situation. In some examples, each control device receives the same fire event-indicating signal and actuates in response to the signal, such as without independently determining whether to actuate.

As described herein, the fire event can be detected at a location using at least one of a thermal signal, an electrical signal, or a manual signal. A fire event can be detected using a detector and a fire event-indicating signal can be provided from the detector to the first fire suppression device. The fire event can be detected through the thermal signal by detecting a presence of heat that meets or exceeds a specified threshold temperature or a rate-of-rise in temperature, or a combination of both. The fire event can be detected through the electrical signal by detecting smoke as an indication of the fire event. The fire event can be detected through the manual signal by a manual trigger being activated on the first fire suppression device.

At operation 555, the method 550 includes dispensing a first aerosol fire suppression agent from the first fire suppression device. The dispensing of the first aerosol fire suppressant agent can be delayed a specified period of time after the communication of the fire event-indicating signal to the first fire suppression device. In some examples, whether to perform the delay and/or the period of time for the delay can be determined by a control device of each of the fire suppression devices. In some examples, whether to perform the delay and the period of time of the delay can be determined by the inputs 110 or other controller that sends the fire event-indicating signal, and/or a delay-indicating signal can be communicated with the fire event-indicating signal. During the specified period of time, at least one ventilation system at a location of the first fire suppression device can be shut down to maintain a specified aerosol density once the first aerosol fire suppression agent is dispensed.

At operation 557, the method 550 includes communicating s second fire event-indicating signal from the first fire suppression device to a second fire suppression device. The second fire suppression device can communicate a third fire event-indicating signal to a third suppression device and so forth in a daisy-chain fashion through multiple fire suppression devices. The first and second fire suppression devices can actuate aerosol generators. While the above description includes receiving a first unique signal at the first fire suppression device and second a second unique signal at the second fire suppression device, examples are not so limited. For example, the first fire event-indicating signal may be passed through the first fire suppression device to the second fire suppression device as a same signal and so forth through the third fire suppression device and to additional fire suppression devices.

At operation 559, the method 550 includes dispensing an aerosol fire suppression agent from the second fire suppression device at the location. The method 550 can further include diminishing the fire event at the location by dispensing the aerosol fire suppression agent from the first and second fire suppression devices.

In some examples, a method can be performed using a fire suppression system including a first fire suppression device and a second fire suppression device. The first fire suppression device can include a first aerosol generator and a first control circuit. The first control circuit can be configured to receive an indication of a fire presence of an elevated temperature at a location and actuate the first fire suppression device to dispense an aerosol fire suppression agent from the first aerosol generator at the location. The first control circuit can be further configured to send a message to a second fire suppression device. The message can be the same message received by the first fire suppression device or can be a different message. The second fire suppression device can include a second aerosol generator and a second control circuit. The second control circuit can be configured to receive the message from the first fire suppression device and actuate the second fire suppression device to dispense an aerosol fire suppression agent from the second aerosol generator at the location.

In some examples, the received indication of the fire event comprises one of a thermal trigger, an electrical trigger, or a manual trigger. The first control circuit can be configured to delay the dispensing of the aerosol fire suppression agent a specified period of time after receiving the indication of the fire event. The first control circuit can be configured to send a message to an external device to, in response to initiating the delay for the specified period of time, perform one of shutting down at least one piece of equipment or close a ventilation system. The first fire suppression device can include a light that indicates a status of the first fire suppression device. The status of the first fire suppression device can include one of a battery life, a main or reserve power quantity, and whether the aerosol fire suppression agent has been dispensed from the first aerosol generator. The first fire suppression device and the second fire suppression device can be part of a plurality of fire suppression devices. In response to at least one of the plurality of fire suppression devices receiving the indication of a fire presence of an elevated temperature at a location, the at least one fire suppression device communicates with each of the other fire suppression devices of the plurality of fire suppression devices to dispense their respective aerosol fire suppression agents.

In some examples, a fire suppression device can include an input. The input can be configured to detect a fire event or a parameter associated with a fire event and send a signal to a first of the plurality of fire suppression devices that the fire event or the parameter has been detected. In response to receiving the signal from the input, the first fire suppression device can be configured to dispense an aerosol fire suppression agent from the first fire suppression device and send a signal to a second fire suppression device of the plurality of fire suppression devices to dispense additional aerosol fire suppression agent from the second fire suppression device and send a signal to a third fire suppression device of the plurality of fire suppression devices to dispense further aerosol fire suppression agent from the third fire suppression device. Further, subsequent fire suppression devices of the plurality of fire suppression devices can be configured to repeat sending a fire event-indicating signal and dispensing of its respective aerosol fire suppression agent. The input can be configured to detect a fire event or a parameter associated with a fire event in response to a set of criteria associated with specified combination of thermal or electrical parameters. The input can be configured to send a signal to trigger a horn or strobe annunciator to alert personnel of the fire event or the parameter.

### VARIOUS NOTES

The following Aspects provide a non-limiting overview of the fire suppression systems, system components, and fire suppression methods discussed herein.

Aspect 1 can include or use subject matter (such as an apparatus, a system, a device, a method, a means for performing acts, or a device readable medium including instructions that, when performed by the device, can cause the device to perform acts), such as can include or use a method for suppressing a fire event, the method comprising communicating the fire event to a plurality of fire suppression devices. In Aspect 1, communicating the fire event can include in response to receiving the first fire event-indicating signal, dispensing a first aerosol fire suppression agent from the first fire suppression device and communicating a second fire event-indicating signal from the first fire suppression device to a second fire suppression device. Aspect 1 can further include, in response to receiving the second fire event-indicating signal, dispensing a second aerosol fire suppression agent from the second fire suppression device.

Each of these non-limiting Aspects can stand on its own, or can be combined in various permutations or combinations with one or more of the other Aspects and examples discussed herein.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods, such as fire extinguishment control system methods, as described in the above examples, such as to initiate release of an extinguishing agent from a water-based or aerosol-based system. In an example, the instructions can include instructions to receive sensor data from one or more sensors in or near a protect environment and, based on the sensor data, initiate the agent release. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method for fire suppression, comprising:
receiving a first fire event-indicating signal at a first fire suppression device;
in response to receiving the first fire event-indicating signal:
dispensing a first aerosol fire suppression agent from the first fire suppression device; and
communicating a second fire event-indicating signal from the first fire suppression device to a second fire suppression device;
and
in response to receiving the second fire event-indicating signal:
dispensing a second aerosol fire suppression agent from the second fire suppression device.

2. The method of claim 1, comprising diminishing a fire event associated with the fire event-indicating signal by dispensing the aerosol fire suppression agent from the first and second fire suppression devices.

3. The method of claim 1, comprising detecting a fire event using a detector and providing the first fire event-indicating signal from the detector to the first fire suppression device, wherein detecting the fire event includes detecting a presence of heat that meets or exceeds a specified threshold temperature or detecting a rate-of-rise in temperature.

4. The method of claim 1, comprising detecting a fire event using a detector and providing the first fire event-indicating signal from the detector to the first fire suppression device, wherein detecting the fire event includes detecting smoke as an indication of the fire event.

5. The method of claim 1, comprising detecting a fire event using a detector and providing the first fire event-indicating signal from the detector to the first fire suppression device, wherein detecting the fire event includes activating a manual trigger on the first fire suppression device.

6. The method of claim 1, further comprising communicating a third fire event-indicating signal to a third suppression device and so forth in a daisy-chain fashion through multiple fire suppression devices.

7. The method of claim 1, further comprising, subsequent to receiving the first fire event-indicating signal and prior to dispensing the first aerosol fire suppression agent, determining, at a control device of the first fire suppression device, whether to dispense the first aerosol fire suppression agent.

8. The method of claim 1, further comprising delaying the dispensing of the first aerosol fire suppressant agent by a specified period of time after receiving the first fire event-indicating signal at the first fire suppression device.

9. The method of claim 8, further comprising shutting down a ventilation system in a vicinity of the first fire suppression device and the second fire suppression device to maintain a specified aerosol density once the aerosol fire suppression agent is dispensed.

10. A system for fire suppression, comprising:
a first fire suppression device and a second fire suppression device, wherein the first fire suppression device comprises:
a first aerosol generator; and
a first control circuit configured to:
receive a fire event-indicating signal;
in response to the received fire event-indicating signal, actuate a first fire suppression device to dispense an aerosol fire suppression agent from the first aerosol generator; and
in response to the received fire event-indicating signal, send a message to the second fire suppression device;
wherein the second fire suppression device comprises:
a second aerosol generator; and
a second control circuit configured to:
receive the message from the first fire suppression device; and
in response to the received message, actuate a second fire suppression device to dispense an aerosol fire suppression agent from the first aerosol generator.

11. The system of claim 10, comprising an input device configured to provide the fire event-indicating signal, wherein the input device comprises a thermal sensor, a chemical sensor, or a switch.

12. The system of claim 10, wherein the first control circuit is configured to delay the dispensing of the aerosol fire suppression agent by a specified period of time after receiving the fire event-indicating signal.

13. The system of claim 12, wherein the first control circuit is configured to send a message to an external device to, in response to initiating the delay for the specified period of time, shut down at least one piece of equipment or close a ventilation system.

14. The system of claim 10, wherein the first fire suppression device comprises a light that indicates a status of the first fire suppression device.

15. The system of claim 14, wherein the status of the first fire suppression device comprises one of a remaining battery life, a main or reserve power availability, and whether the aerosol fire suppression agent has been dispensed from the first aerosol generator.

16. The system of claim 10, wherein:
the first fire suppression device and the second fire suppression device are part of a network of a plurality of fire suppression devices;
in response to at least one of the plurality of fire suppression devices receiving the fire event-indicating signal, the at least one fire suppression device instructs each of other fire suppression devices of the plurality of fire suppression devices to dispense their respective aerosol fire suppression agents.

17. A system for fire suppression, comprising:
a plurality of fire suppression devices, each comprising:
an aerosol generator; and
a control circuit in communication with the respective aerosol generator;
an input device configured to:
detect a fire event or a parameter associated with a fire event; and
send a fire event-indicating signal to a first of the plurality of fire suppression devices;
wherein, in response to receiving the fire event-indicating signal from the input device, the first fire suppression device is configured to:
dispense an aerosol fire suppression agent from the first fire suppression device; and
send the fire event-indicating signal to a second fire suppression device of the plurality of fire suppression devices;
wherein, in response to receiving the fire event-indicating signal, the second fire suppression device is configured to:
dispense a second aerosol fire suppression agent; and
send the fire event-indicating signal to a third fire suppression device of the plurality of fire suppression devices to dispense a third aerosol fire suppression agent from the third fire suppression device.

18. The system of claim 17, wherein each of the other fire suppression devices of the plurality of fire suppression devices is configured to repeat sending the fire event-indicating signal and dispensing of its respective aerosol fire suppression agent.

19. The system of claim 17, wherein the input device is configured to detect a fire event or a parameter associated with a fire event in response to a set of criteria associated with a specified combination of thermal, chemical, or electrical parameters.

20. The system of claim 17, wherein the input device is configured to send a signal to trigger a horn or strobe annunciator to alert personnel of the fire event or the parameter.
